(19) United States
(12) Patent Application Publication
(10) Pub. No.: US 2025/0369674 A1
(43) Pub. Date: Dec. 4, 2025

(54) AIR CONDITIONING CONTROL SYSTEM AND AIR CONDITIONING CONTROL METHOD

(71) Applicant: QINGDAO HISENSE HITACHI AIR-CONDITIONING SYSTEMS CO., LTD., Shandong (CN)

(72) Inventors: Xuexiang JIANG, Qingdao (CN); Jinwei ZHOU, Qingdao (CN); Xizhi LI, Qingdao (CN); Zhaoting REN, Qingdao (CN); Haojie YIN, Qingdao (CN)

(73) Assignee: QINGDAO HISENSE HITACHI AIR-CONDITIONING SYSTEMS CO., LTD., Shandong (CN)

(21) Appl. No.: 19/306,955

(22) Filed: Aug. 21, 2025

Related U.S. Application Data
(63) Continuation of application No. PCT/CN2024/077919, filed on Feb. 21, 2024.

(30) Foreign Application Priority Data
Feb. 27, 2023 (CN) 202310173114.5

(51) Int. Cl. F25B 49/02

(52) U.S. Cl. CPC F25B 49/025; F25B 2600/021; F25B 2600/0253

(57) ABSTRACT

An air conditioning control system including a motor and a controller is provided. The controller is configured to: filter a received signal using a filter function Q(Z), where the received signal is a difference between a feedback value of an electrical angular velocity of the motor and a given value of the electrical angular velocity of the motor; perform phase compensation on the filtered signal using a phase compensation function S(Z); determine a motor speed control signal, using a speed regulation function Gpi(Z), based on the phase-compensated signal; and discretize the motor speed control signal using a discrete transfer function Gp(Z), and control a speed of the motor based on the discretized motor speed control signal. Poles of a transfer function of the controller constructed based on the functions Q(Z), S(Z), Gpi(Z), and Gp(Z) are located within a unit circle.

### CROSS-REFERENCE TO RELATED APPLICATION

This is a continuation application of International Patent Application No. PCT/CN2024/077919 filed on Feb. 21, 2024, which claims the priority benefits of China Application No. 202310173114.5 filed on Feb. 27, 2023. The entire contents of the above-mentioned patent application are incorporated by reference herein and made a part of this specification.

### TECHNICAL FIELD

The present disclosure relates to the field of motor control technology, and particularly to an air conditioning control system and an air conditioning control method.

### DESCRIPTION OF RELATED ART

A variable frequency air conditioner can adjust the operating frequency of a compressor through an inverter, thereby changing the speed of the compressor to achieve room temperature control. When the room temperature reaches a set temperature, the compressor of the variable frequency air conditioner enters a low-frequency operation mode to reduce energy consumption, minimize room temperature fluctuations, avoid frequent starts of the compressor, and extend the compressor's lifespan.

### SUMMARY OF THE INVENTION

An air conditioning control system is provided, including a motor and a controller. The controller is coupled to the motor. The controller is configured to:
filter a received signal by means of a filter function Q(Z), wherein the received signal is a difference between a feedback value of an electrical angular velocity of the motor and a given value of the electrical angular velocity of the motor;
perform phase compensation, by means of a phase compensation function S(Z), on the filtered signal;
determine a motor speed control signal, by means of a speed regulation function Gpi(Z), according to the phase-compensated signal;
discretize the motor speed control signal by means of a discrete transfer function Gp(Z), and control a speed of the motor based on the discretized motor speed control signal;
where poles of a transfer function of the controller constructed based on the functions Q(Z), S(Z), Gpi(Z), and Gp(Z) are located within a unit circle.

### BRIEF DESCRIPTION OF THE DRAWINGS

FIG. 1 is a structural diagram of an air conditioning control system according to some embodiments.

FIG. 2 is a schematic diagram of a motor according to some embodiments.

FIG. 3 is a schematic diagram of another motor according to some embodiments.

FIG. 4 is another structural diagram of an air conditioning control system according to some embodiments.

FIG. 5 is yet another structural diagram of an air conditioning control system according to some embodiments.

FIG. 6 is yet another structural diagram of an air conditioning control system according to some embodiments.

FIG. 7 is a phase-frequency diagram according to some embodiments.

FIG. 8 is an amplitude-frequency diagram according to some embodiments.

FIG. 9 is yet another structural diagram of an air conditioning control system according to some embodiments.

FIG. 10 is a speed waveform diagram without the addition of a controller according to some embodiments.

FIG. 11 is a speed waveform diagram with the addition of a controller according to some embodiments.

### DESCRIPTION OF THE EMBODIMENTS

Some embodiments of the present disclosure are clearly and completely described below with reference to the accompanying drawings, and apparently, the described embodiments are not all but only a part of the embodiments of the present disclosure. All other embodiments obtained by a person of ordinary skill in the art based on the embodiments of the present disclosure shall fall within the protection scope of the present disclosure.

Unless otherwise required in the context, throughout the specification and claims, the term “comprise” and its other forms such as “comprises” and “comprising” are interpreted as open and inclusive, meaning “including, but not limited to”. In the description of the specification, terms such as “one embodiment”, “some embodiments”, “exemplary embodiments”, “example”, “specific example”, or “some examples” are intended to indicate that specific features, structures, materials, or characteristics related to that embodiment or example are included in at least one embodiment or example of the present disclosure. The illustrative representation of the above terms does not necessarily refer to the same embodiment or example. Moreover, the described specific features, structures, materials, or characteristics may be included in any one or more embodiments or examples in any appropriate manner.

Hereinafter, the terms such as “first” and “second” are used only for purposes of description and should not be understood as indicating or implying relative importance or implicitly indicating the number of indicated technical features. Thus, features defined as “first” and “second” may explicitly or implicitly include one or more of these features. In the description of the embodiments of the present disclosure, unless otherwise specified, “multiple” means two or more.

When describing some embodiments, “coupled”, “connected”, and their derived expressions may be used. The term “connected” should be interpreted broadly. For example, “connected” may be a fixed connection, a detachable connection, or an integral connection. It may be a direct connection or an indirect connection through an intermediate medium. The term “coupled” indicates, for example, that two or more components are in direct physical or electrical contact. The term “coupled” or “communicatively coupled” may also mean that two or more components cooperate or interact with each other without direct contact. The embodiments disclosed herein are not necessarily limited to the content described herein.

“A and/or B” includes the following three cases: A alone, B alone, and a combination of A and B.

The use of “adapted to” or “configured to” herein means open and inclusive language, which does not exclude devices adapted to or configured to perform additional tasks or steps.

Additionally, the use of “based on” means open and inclusive, as a process, step, calculation, or other action that is “based on” one or more stated conditions or values may, in practice, be based on additional conditions or values beyond those stated.

Hereinafter, the proprietary terms involved in the present disclosure are described.

The cut-off frequency refers to the frequency of the input signal at which, while maintaining a constant amplitude of the input signal, the output signal drops to 0.707 times the maximum value, i.e., the −3 db point in terms of the frequency response characteristic. The cut-off frequency is a special frequency configured to describe frequency characteristics. Additionally, the cut-off frequency also refers to a boundary frequency (usually with −3 dB as the boundary) at which the energy of the output signal of a system begins to decrease or increase in a band-stop filter.

The low-pass filtering, also known as high-frequency cut filtering or treble-cut filtering, is a filtering method which has a filtering rule that low-frequency signals with a frequency smaller than the cut-off frequency can pass through normally, while high-frequency signals with a frequency greater than the cut-off frequency are blocked or attenuated during the filtering process. The degree of blocking or attenuation of high-frequency signals will vary depending on different frequencies and different filtering programs (purposes).

The low-pass filter refers to an electronic filtering device that allows signals with the frequency smaller than the cut-off frequency to pass through, but does not allow signals with the frequency larger than the cut-off frequency to pass through.

The Park's transformation is one of the most commonly used coordinate transformations for analyzing the operation of synchronous motors. Park's transformation projects three-phase currents a, b and c of a stator onto a direct axis (d-axis) rotating with a rotor, a quadrature axis (q-axis), and a zero axis (0-axis) perpendicular to a d-q plane, that is, transforming an abc coordinate system to a dq coordinate system, thereby achieving diagonalization of a stator inductance matrix and simplifying the operation analysis of synchronous motor.

The permanent-magnet synchronous motor (PMSM) refers to a type of synchronous motor in which the rotor uses a permanent magnet instead of a winding.

The Proportional-Integral Controller (PI controller) is a linear controller that obtains a control deviation based on a given value and an actual output value, and combines the proportion and integral of the deviation linearly to generate a control signal to regulate the controlled object.

The transfer function refers to a ratio of a Laplace transform (or z-transform) of a response quantity (i.e., output quantity) to a Laplace transform of an excitation quantity (i.e., input quantity) of a linear system under a zero initial condition. The transfer function is denoted as G(s)=Y(s)/U(s), where Y(s) and U(s) are the Laplace transforms of the output quantity and input quantity, respectively.

A variable frequency air conditioner can adjust the operating frequency of a compressor through an inverter, thereby changing the speed of the compressor to achieve room temperature control. When the room temperature reaches a preset temperature, the compressor of the variable frequency air conditioner enters a low-frequency operation mode to reduce energy consumption, minimize room temperature fluctuations, avoid frequent starts of the compressor, and extend the compressor's lifespan.

However, when the compressor operates at a speed lower than a preset speed, the current on the q-axis (i.e., quadrature axis) that controls the electromagnetic torque of the motor in the compressor cannot be adjusted instantly or rapidly to adapt to sudden changes in load torque, resulting in an imbalance between the electromagnetic torque and the load torque, which in turn causes significant pulse-like fluctuations in the compressor's speed. Consequently, the compressor cannot operate stably, leading to severe vibrations in the air conditioner 200.

It can be understood that the compressor achieves temperature control by drawing in low-temperature, low-pressure gaseous refrigerant and discharging high-temperature, high-pressure gaseous refrigerant to exchange heat. When the compressor operates at a speed higher than the preset speed, due to the shorter compression cycle of the compressor, the fluctuations in the compression cycle are smooth. However, when the compressor operates at a speed lower than the preset speed, due to the longer compression cycle of the compressor, the fluctuations in the compression cycle become pronounced. This not only makes the internal pipes of the air conditioner prone to damage, reducing the air conditioner's lifespan, but also results in significant noise when the compressor operates at a speed lower than the preset speed.

In the related art, torque compensation is applied to the motor of the compressor, for example, by controlling the generation of pulsations related to the motor torque of the compressor to suppress the problem of significant fluctuations in the compression cycle when the compressor operates at a speed lower than the preset speed. However, torque compensation for the motor of the compressor requires high precision and complex operations.

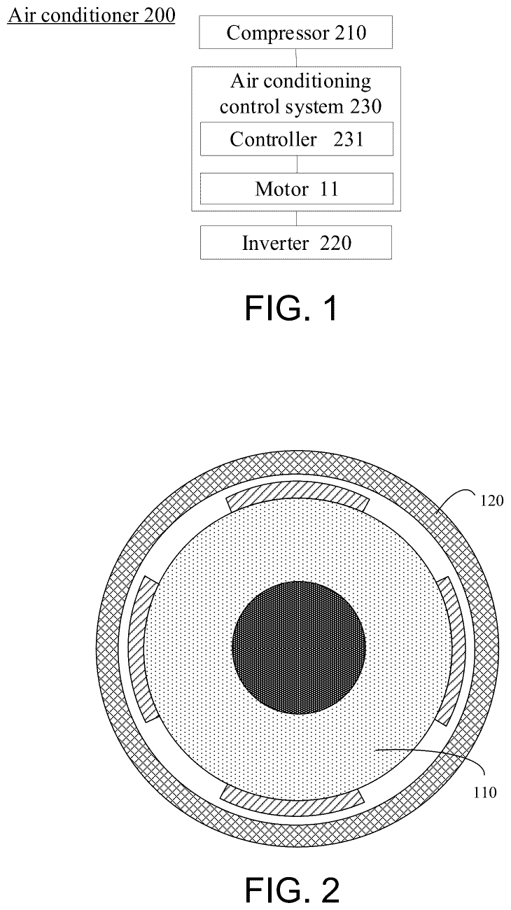

To solve the above problems, in some embodiments of the present disclosure, as shown in FIG. 1, the present disclosure provides an air conditioner 200 (for example, a variable frequency air conditioner). The air conditioner 200 includes a compressor 210, which is configured to compress refrigerant to drive the refrigerant to circulate in the air conditioner 200.

The air conditioner 200 also includes an inverter 220. The air conditioner 200 can adjust the operating frequency of the compressor 210 through the inverter 220 to change the speed of the compressor 210, thereby achieving room temperature control. When the room temperature reaches the preset temperature, the compressor 210 enters a low-frequency operation mode, that is, the compressor 210 operates at a speed lower than a preset speed, which effectively reduces the power consumption of the air conditioner 200 during operation while reducing room temperature fluctuations and avoiding excessive starts of the compressor 210 within a preset time period, thereby extending the lifespan of the compressor 210.

In some embodiments, as shown in FIG. 1, the air conditioner 200 also includes an air conditioning control system 230, which is coupled to the compressor 210 and the inverter 220. The air conditioning control system 230 includes a controller 231 (for example, a repetitive controller) and a motor 11. The controller 231 is coupled to the motor 11 and is configured to regulate the speed of the motor 11.

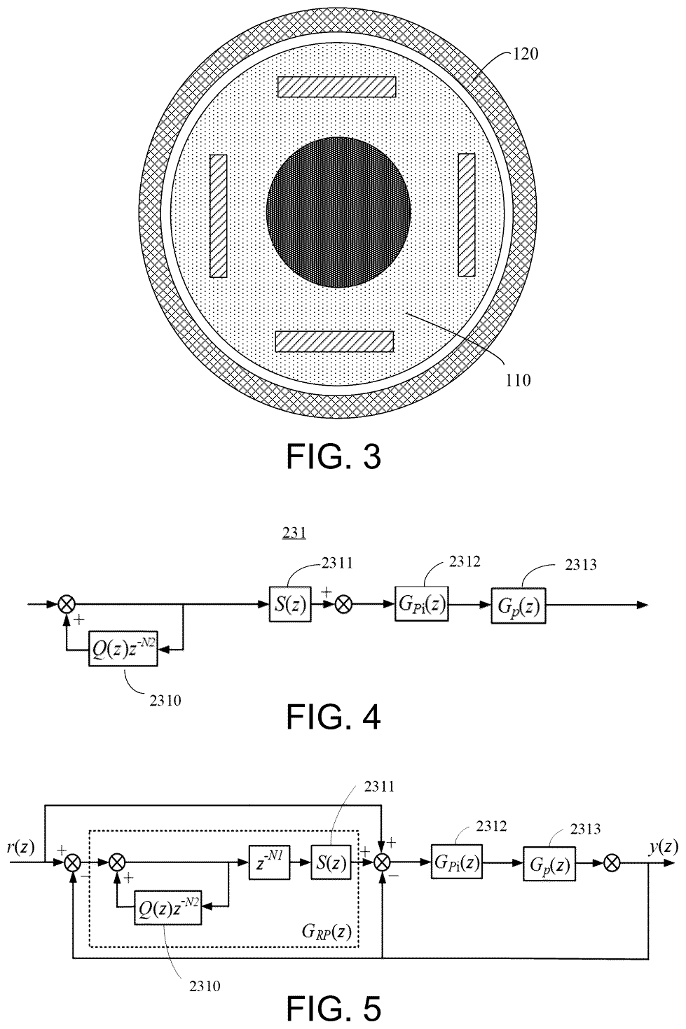

In some embodiments, the motor 11 is, for example, a permanent-magnet synchronous motor. As shown in FIG. 2 and FIG. 3, the motor 11 includes a rotor 110, which includes, for example, magnetic poles and a rotor core. In some embodiments, as shown in FIG. 2, the motor 11 is, for example, a surface-mounted permanent-magnet synchronous motor, i.e., the magnetic poles are mounted on the surface of the rotor core. In other embodiments, as shown in FIG. 3, the motor 11 is, for example, an interior permanent-magnet synchronous motor, i.e., the magnetic poles are arranged inside the rotor core.

In some embodiments, as shown in FIG. 2 and FIG. 3, the motor 11 also includes a stator 120, which is, for example, a stator coil. The stator 120 is configured to generate a rotating magnetic field, such that the rotor 110 cuts magnetic field lines in the rotating magnetic field, thereby generating current. The stator 120 includes a stator core and stator windings. The stator windings are, for example, three-phase stator windings.

In some embodiments, as shown in FIG. 4, the controller 231 includes a low-pass filter 2310, which, for example, includes a cycle delay device Z^{-N}. In this case, the cycle delay device is configured to delay the control and response of the low-pass filter by one cycle. The low-pass filter 2310 is configured with a filter function Q(Z) in the discrete domain. The low-pass filter is, for example, a logic controller and is configured to filter out signals with the frequency greater than the cut-off frequency and allow signals with the frequency less than the cut-off frequency to pass using the function.

In some embodiments, the low-pass filter 2310 filters a speed difference r(Z) of the motor, where the speed difference r(Z) is the difference between a feedback value of an electrical angular velocity of the motor 11 and a given value of the electrical angular velocity of the motor 11.

In some embodiments, as shown in FIG. 4, the controller 231 also includes a compensator 2311. The compensator 2311 is configured with a phase compensation function S(Z) in the discrete domain. The compensator 2311 is coupled to the low-pass filter 2310 and is configured to perform phase compensation on the delayed signal that passes through the low-pass filter 2310 using the function S(Z). The compensator is, for example, a logic controller.

In some embodiments, the compensator 2311 performs phase compensation on the speed difference filtered by the low-pass filter 2310 using the function S(Z).

In some embodiments, as shown in FIG. 4, the controller 231 also includes a speed regulator 2312, which is coupled to the compensator 2311. The speed regulator 2312 is configured with a speed regulation function Gpi(Z) in the discrete domain, and is configured to regulate the speed of the motor 11 of the compressor 210 through the function Gpi(Z). The speed regulator is, for example, a proportional and integral regulator.

In some embodiments, the speed difference after phase compensation by the compensator 2311 is input to the speed regulator 2312 for PI control of the speed loop. The speed regulator 2312 outputs a motor speed control signal for controlling the speed of the motor. For example, the motor speed control signal is a q-axis current control signal, and the motor speed can be regulated by regulating the q-axis current of the motor.

In some embodiments, as shown in FIG. 4, the controller 231 also includes a discrete transfer device 2313, which is coupled to the speed regulator 2312. The discrete transfer device 2313 is configured with a discrete transfer function Gp(Z) in the discrete domain, and is configured to discretize the continuous signal output by the speed regulator 2312 through the discrete transfer function. The discrete transfer device is, for example, a logic controller.

In some embodiments, after the discrete transfer device 2313 discretizes the continuous motor speed control signal output by the speed regulator 2312, the controller 231 controls the motor based on the discretized motor speed control signal. For example, after the continuous q-axis current control signal is discretized, the motor is controlled according to the discretized q-axis current control signal.

Since the actual control process of the controller is periodic, the control signal is output once per cycle, it is necessary to discretize the continuous control signal output by the speed regulator.

In some embodiments, as shown in FIG. 5, the controller 231 also includes a cycle delay device Z^{-N}. The cycle delay device Z^{-N} is coupled to both the low-pass filter and the compensator, and is configured to delay the control and response of the controller by one cycle.

In some embodiments, as shown in FIG. 5, the controller 231 is configured to: receive an input speed difference r(Z), and through a transfer function of the controller 231, output a target speed signal y(Z). Here, the speed difference r(Z) is the difference between the given value of the electrical angular velocity of the motor 11 and the feedback value of the electrical angular velocity of the motor 11. The target speed signal is the actual speed signal of the motor after adjustment. The motor rotating at the speed corresponding to the target speed signal can avoid motor vibration caused by speed fluctuations.

In some embodiments, the controller 231 is also configured to: when the difference between the feedback value and the given value of the electrical angular velocity of the motor 11 is not zero, adjust the value of the input speed to make the feedback value of the electrical angular velocity approach the given value. The speed value output by the air conditioning control system is equal to the target speed signal y(Z).

For example, when the difference between the feedback value and the given value of the electrical angular velocity of the motor 11 is greater than 0, the value output by the controller 231 is greater than zero, the command value of the air conditioning control system 230 (i.e., the speed difference r(Z)) increases, causing the output value (i.e., the value of the q-axis current control signal) to increase under the action of the speed regulator. In this case, although the difference between the feedback value and the given value of the electrical angular velocity of the motor 11 still exists, it tends to 0 under the action of the controller 231, stabilizing the speed of the motor 11.

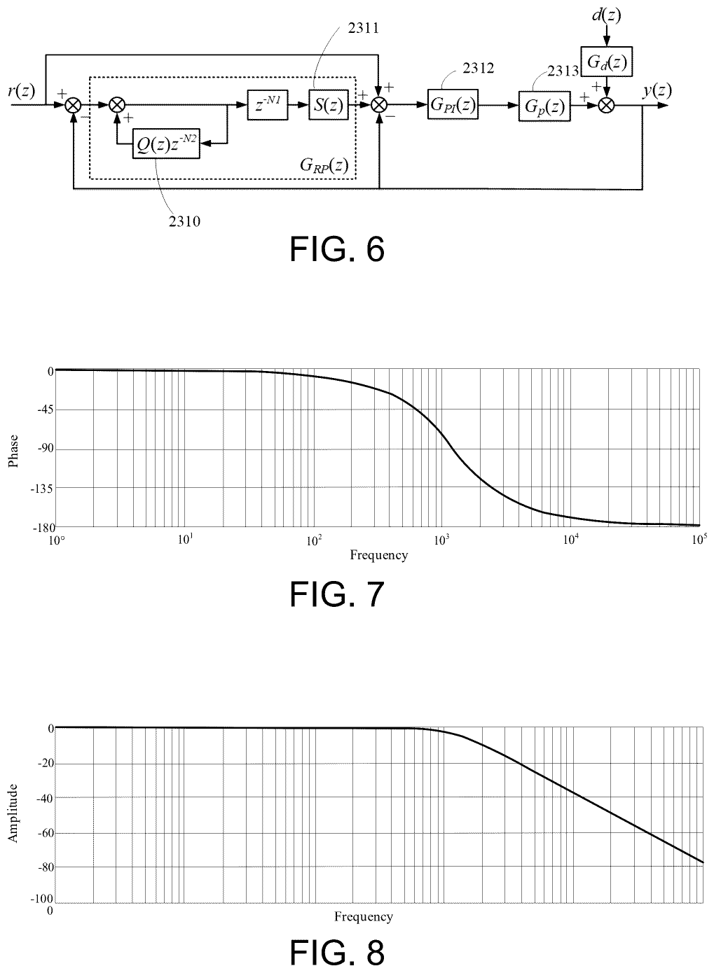

In some embodiments, as shown in FIG. 6, the air conditioning control system 230 is also configured with input noise d(z) and a preset noise transfer function Gd(Z).

In some embodiments, the transfer function of the controller 231 is, for example, formula (1):

$$formula ( 1 )$$

$$y ( Z ) = \frac{Grp ( Z ) [ \frac{Gpi ( Z ) Gp ( Z )}{1 + Gpi ( Z ) Gp ( Z )} ]}{1 + Grp ( Z ) [ \frac{Gpi ( Z ) Gp ( Z )}{1 + Gpi ( Z ) G p ( Z )} ]} r ( Z ) + \frac{Gd ( Z ) / [ \frac{Gpi ( Z ) Gp ( Z )}{1 + Gpi ( Z ) Gp ( Z )} ]}{1 + Grp ( Z ) [ \frac{Gpi ( Z ) Gp ( Z )}{1 + Gpi ( Z ) Gp ( Z )} ]}$$

where y(Z) is the output target speed signal, Grp(Z) is the function of the controller 231, Gpi(Z) is the function of the speed regulator, Gp(Z) is the discrete transfer function of the discrete transfer device, r(Z) is the input speed difference, and Gd(Z) is the preset noise transfer function.

In some embodiments, the function Grp(Z) of the controller 231 in formula (1) can be obtained according to formula (2):

$$Grp ( Z ) = \frac{{Z}^{- N} S ( Z )}{1 - {Z}^{- N} Q ( Z )} \qquad formula ( 2 )$$

where Grp(Z) is the function of the controller 231, Z^{-N} is the function of the cycle delay device of the controller 231, S(Z) is the function of the compensator in the discrete domain, and Q(Z) is the function of the low-pass filter in the discrete domain.

The necessary and sufficient condition for the stability of the air conditioning control system 230 is that the poles of the closed-loop transfer function (for example, the speed closed-loop function) are located within the unit circle, that is, the roots of formula (3) are located within the unit circle.

$$1 + Grp ( Z ) [ \frac{Gpi ( Z ) Gp ( Z )}{1 + Gpi ( Z ) Gp ( Z )} ] = 0 \qquad Formula ( 3 )$$

Here, Grp (Z) is the function of the controller 231, Gpi(Z) is the function of the speed regulator, and Gp(Z) is the discrete transfer function of the discrete transfer device.

Formula (4) is obtained by substituting formula (3) into formula (1).

$$Δ = 1 - {Z}^{- N} [ Q ( Z ) - S ( Z ) \frac{Gpi ( Z ) Gp ( Z )}{1 + Gpi ( Z ) Gp ( Z )} ] = 0 \qquad Formula ( 4 )$$

Here, Z^{-N} is the cycle delay device of the controller 231, S(Z) is the function of the compensator, Q(Z) is the function of the low-pass filter, Gpi(Z) is the function of the speed regulator, and Gp(Z) is the discrete transfer function of the discrete transfer device.

In some embodiments, the controller 231 is configured to: determine a target value through a first function relationship based on the function Q(Z) of the low-pass filter in the discrete domain, the function S(Z) of the compensator in the discrete domain, the function Gpi(Z) of the speed regulator in the discrete domain, and the discrete transfer function Gp(Z) of the discrete transfer device in the discrete domain, and the target value is less than 1. Here, the target value determined through the first function relationship being less than 1 is represented, for example, by formula (5). That is, Q(Z), S(Z), Gpi(Z), and Gp(Z) satisfy formula (5):

$$\vert Q ( Z ) - S ( Z ) \frac{Gpi ( Z ) Gp ( Z )}{1 + Gpi ( Z ) Gp ( Z )} \vert < 1 \qquad formula ( 5 )$$

This ensures that the transfer function of the controller 231 satisfies the stability condition of the air conditioning control system 230, avoiding severe vibrations of the air conditioner 200 when the compressor 210 operates at a speed lower than the preset speed, thus enabling stable operation of the air conditioner 200.

In some embodiments, since the value of the function Gpi(Z) of the speed regulator and the discrete transfer function Gp(Z) of the discrete transfer device are known and determined, based on the above formula (5), it can be seen that to achieve stability of the air conditioning control system 230 including the controller 231, the parameter design of the function Q(Z) of the low-pass filter and the function S(Z) of the compensator in the discrete domain needs to be considered.

When the air conditioning control system 230 operates in the low-frequency band, that is, when |Q(Z)−Gp(Z)S(Z)|<1, the air conditioning control system 230 is stable. In this case, the amplitude of the low-pass filter should be close to 1 to ensure sufficient attenuation of the error signal at the repetition frequency, thereby ensuring the steady-state characteristics of the air conditioning control system 230. When the air conditioning control system 230 operates in the high-frequency band, that is, when |1−Gp(Z)S(Z)|>1, the amplitude of the low-pass filter should be attenuated to less than 1 to ensure the stability of the air conditioning control system 230.

In some embodiments, the low-pass filter is, for example, a Butterworth low-pass filter, which improves the response speed and stability of the air conditioning control system 230.

When the air conditioning control system 230 operates in the low-frequency band, the low-pass filter has an approximately linear phase-frequency characteristic, so it is necessary to add a phase lead component to compensate for the phase lag. Therefore, the structure of the low-pass filter is, for example, as shown in formula (6):

$$Q ( Z ) = q ( Z ) * {Z}^{n} \qquad formula ( 6 )$$

where Q(Z) is the function of the low-pass filter, q(Z) is a filtering function, and Zⁿ is a compensation function. In some embodiments, in the compensation function Zⁿ, n=16.

In some embodiments, the low-pass filter may be a second-order Butterworth low-pass filter.

In other embodiments, the low-pass filter may be a first-order low-pass filter.

An amplitude-frequency characteristic diagram and a phase-frequency characteristic diagram can be obtained based on the discrete transfer function Gp(Z), and a discrete transfer function Gp(s) in the complex frequency domain is, for example, as shown in formula (7):

$$Gp ( s ) = \frac{Kp}{{LT}^{2} + Ls + Kp} = \frac{\frac{Kp}{LT}}{{s}^{2} + \frac{1}{T} + \frac{Kp}{LT}} \qquad formula ( 7 )$$

where Gp(s) is the discrete transfer function in the complex frequency domain, Kp is a current loop proportional coefficient, T is a current loop operation period, L is a dq-axis equivalent inductance, and s is a complex variable in the complex domain.

The discrete transfer function Gp(Z) in the discrete domain is, for example, as shown in formula (8):

$$Gp ( z ) = \frac{\frac{Kp}{LT}}{\frac{{( Z - 1 )}^{2}}{{T}^{2}} + \frac{Z - 1}{{T}^{2}} + \frac{Kp}{LT}} \qquad formula ( 8 )$$

where Gp(Z) is the discrete transfer function in the discrete domain, Kp is the current loop proportional coefficient, T is the current loop operation period, L is the dq-axis equivalent inductance, and Z is the discrete variable in the discrete domain.

FIG. 7 shows a relationship between the phase and frequency of the transfer function of the controller. FIG. 8 shows a relationship between the magnitude and frequency.

In some embodiments, as shown in FIG. 7 and FIG. 8, in the complex frequency domain, the phase decreases as the frequency increases, i.e., the phase is negatively correlated with frequency. The magnitude decreases as the frequency increases, i.e., the amplitude is negatively correlated with frequency.

From the Bode plot of the transfer function in the complex frequency domain shown in FIG. 7 and FIG. 8, it can be seen that the magnitude of the system transfer function is 0 in the low-frequency band. A conversion formula from the complex frequency domain to the discrete domain is, for example, formula (9):

$$Z = {e}^{T} \qquad formula ( 9 )$$

where Z is the discrete variable in the discrete domain, e is a natural constant, and T is the current loop operation period.

The magnitude of the discrete transfer function of the air conditioning control system 230 approaches 1 in the low-frequency band. Based on the phase-frequency and amplitude-frequency characteristics of the discrete transfer function, the filtering function of the low-pass filter in the discrete domain can be determined, for example, as formula (10):

$$q ( Z ) = ( K 1 * Z + K 2 ) / ( {Z}^{2} - K 3 * Z + K 4 ) \qquad formula ( 10 )$$

where Z is the discrete variable in the discrete domain, q(Z) is the filtering function of the low-pass filter in the discrete domain, K1 is a first preset filtering parameter, K2 is a second preset filtering parameter, K3 is a third preset filtering parameter, and K4 is a fourth preset filtering parameter. In some embodiments, K1, K2, K3, and K4 are greater than 0.

For example, when K1 is 0.006302, K2 is 0.004977, K3 is 1.48, and K4 is 0.4915, the filtering function of the low-pass filter in the discrete domain is, for example, as shown in formula (11):

$$q ( Z ) = \frac{0.006302 Z + 0004977}{{Z}^{2} - 1.48 Z + 0.4915} \qquad formula ( 11 )$$

where q(Z) is the filtering function of the low-pass filter in the discrete domain, and Z is the discrete variable in the discrete domain (i.e., the discrete domain operator).

As such, the configured low-pass filter Q(Z) can ensure sufficient attenuation of the error signal at the repetition frequency, guaranteeing the stability of the air conditioning control system 230, and improving the accuracy of the air conditioning control system 230.

In some embodiments, the magnitude and phase of the discrete transfer function Gp(Z) of the compensator are compensated to improve the stability and disturbance rejection capability of the air conditioning control system 230.

In some embodiments, when |1−Gp(Z)S(Z)|=1, the dynamic and static characteristics of the air conditioning control system 230 meet the requirements of the present disclosure. However, due to the low-pass characteristics of the discrete transfer function Gp(Z), the compensator S(Z) will not have the inverse characteristics of the discrete transfer function Gp(Z) across the entire frequency band.

In some embodiments of the present disclosure, the compensator S(Z) adopts a structure, for example, as shown in formula (12):

$$S ( Z ) = q ( Z ) * {Z}^{m} \qquad formula ( 12 )$$

where S(Z) is the function of the compensator, q(Z) is the filtering function of the low-pass filter, and Z^{m} is a phase lead component function. In some embodiments, to satisfy ∠Gp(Z)S(Z)Z^{m}≈0, a value of a phase lead compensation amount m is 13.

In some embodiments, the transfer function in the current complex frequency domain (S domain) is as shown in formula (13):

$$G ( s ) = \frac{Y ( s )}{U ( s )} = \frac{1}{s + 1} \qquad formula ( 13 )$$

where G(s) is the transfer function in the S domain, Y(s) is an input function of the compensator in the S domain, U(s) is an output function of the compensator in the S domain, and s is the complex variable in the complex domain (i.e., the function of the complex domain).

In the case where the low-pass filter is a second-order low-pass filter, s is the second-order system expression symbol value in the complex domain.

The following formula (14) is obtained by discretizing s using a forward difference method:

$$s = \frac{Z + 1}{t} \qquad formula ( 14 )$$

where s is the complex variable in the complex domain, Z is the discrete variable in the discrete domain, and t is a single time step in the discretization process.

As such, the transfer function of the compensator in the discrete domain (Z domain) is determined to be, for example, formula (15):

$$G ( Z ) = \frac{Y ( Z )}{U ( Z )} = \frac{1}{\frac{1 - Z}{t} + 1} \qquad formula ( 15 )$$

where G(Z) is the transfer function of the compensator in the discrete domain, Y(Z) is an input function of the compensator, U(Z) is an output function of the compensator, t is the single time step in the discretization process, and Z is the discrete variable in the discrete domain.

By simplifying and integrating the above formula (15), a relationship between input and output can be obtained, for example, as shown in formula (16):

$$Y ( Z ) = \frac{1}{1 + t} {Z}^{- 1} Y ( Z ) + \frac{t}{1 + t} U ( Z ) \qquad formula ( 16 )$$

where Y(Z) is the input function of the compensator in the discrete domain, U(Z) is the output function of the compensator in the discrete domain, t is the single time step in the discretization process, and Z is the discrete variable in the discrete domain.

It should be noted that in some embodiments of the present disclosure, S(Z)=1 can satisfy the requirements for the discrete transfer function Gp(Z) when the air conditioning control system 230 operates in the low-frequency band.

In some embodiments, since the controller 231 includes the cycle delay device, the error signal of one control cycle can only affect the control quantity of the next control cycle, so the response of the control of the controller 231 is delayed by one cycle.

After the motor 11 reaches the given speed and runs stably, the speed command on the speed control loop of the air conditioning control system 230 is constant, while the feedback speed, which subject to periodic fluctuations caused by periodic fluctuating load, is an alternating quantity, so it is regulated by the controller 231. However, due to the influence of the delay element, the response speed is affected, causing control lag, which needs to be compensated.

In some embodiments, a range of the cut-off frequency of the low-pass filter is, for example, [1, 10] Hz. For example, the cut-off frequency is, 1 Hz, 3 Hz, or 5 Hz.

In some embodiments, the range of the cut-off frequency of the low-pass filter is, for example, [1, 3] Hz, [3, 5] Hz, [5, 8] Hz, [8, 10] Hz.

In some embodiments, a damping of the low-pass filter is greater than a preset threshold.

It can be understood that in some embodiments, a speed overshoot can be reduced by increasing the damping ratio of the low-pass filter.

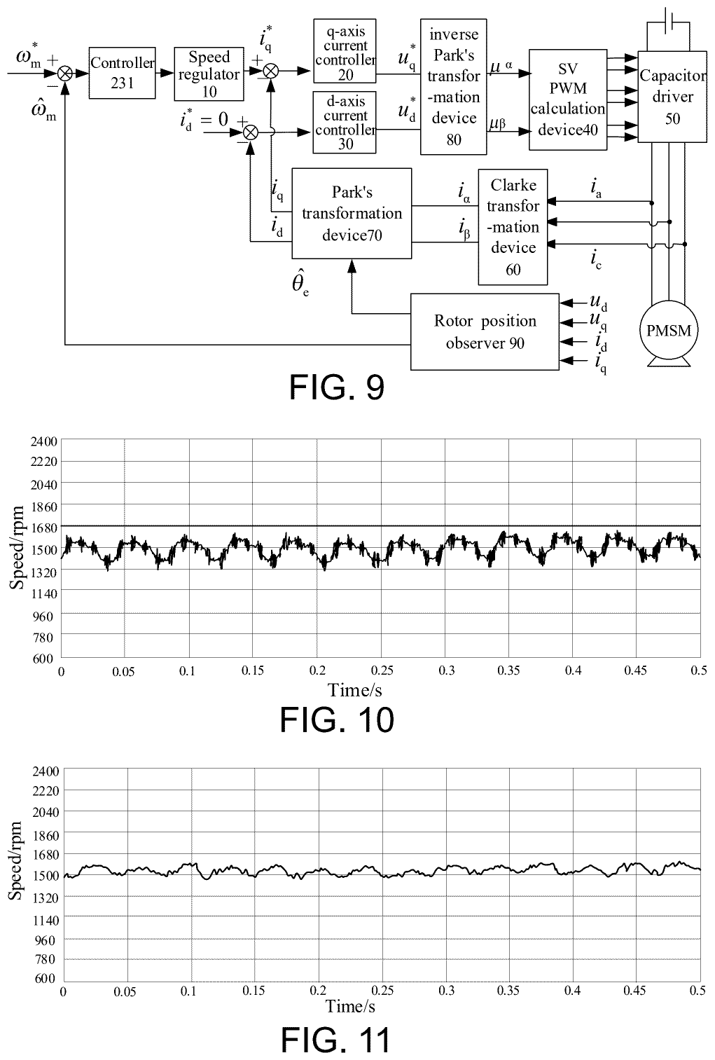

In some embodiments, as shown in FIG. 9, a principle architecture of the air conditioning control system includes a controller (i.e., controller 231), a speed regulator 10, a q-axis current controller 20, a d-axis current controller 30, and a low-pass filter.

In some embodiments, the principle architecture of the air conditioning control system also includes a space vector pulse width modulation (SVPWM) calculation device 40. The space vector pulse width modulation calculation device 40 mainly uses an ideal magnetic flux circle of a three-phase symmetrical motor stator as a reference standard when supplied with a three-phase symmetrical sinusoidal voltage, switches between different switching modes of a three-phase inverter to form PWM waves, i.e., pulse width modulation waveforms, and uses a formed magnetic flux vector to track its accurate magnetic flux circle.

In some embodiments, the principle architecture of the air conditioning control system also includes a capacitor driver 50, which is configured to achieve variable frequency drive.

In some embodiments, the principle architecture of the air conditioning control system also includes a Clarke transformation device 60. The Clarke transformation device 60 is configured to transform currents Iₐ, I_{b} and I_{c} in a three-phase stationary coordinate system of the motor 11 to currents I_{α} and I_{β} in a two-phase stationary coordinate system.

In some embodiments, the principle architecture of the air conditioning control system also includes a Park's transformation device 70. The Park's transformation device 70 is configured to transform the currents I_{α} and I_{β} in the two-phase stationary coordinate system to currents I_{d} and I_{q} in a two-phase rotating coordinate system.

In some embodiments, the principle architecture of the air conditioning control system also includes an inverse Park's transformation device 80. The inverse Park's transformation device 80 is configured to transform and output voltage.

In some embodiments, the principle architecture of the air conditioning control system also includes a rotor position observer 90. The rotor position observer 90 is coupled to the controller and is configured to observe the rotational speed of the rotor of the motor. The controller obtains the rotational speed of the rotor and adjusts the rotational speed of the rotor according to requirements.

In some embodiments, a q-axis current command i_{q}* is calculated through the speed regulator, and a d-axis current command i_{d}* and the q-axis current command i_{q}* are used to obtain a d-axis voltage command u_{d}* and a q-axis voltage command u_{q}* through a current regulator.

The d-axis voltage command u_{d}* and q-axis voltage command u_{q}* are transformed through the inverse Park transformation device to obtain a α-axis voltage u_{α} and β-axis voltage u_{β}, which are input to the space vector pulse width modulation calculation device for system drive control.

As shown in FIG. 10 and FIG. 11, in some embodiments of the present disclosure, under the action of the controller 231, the speed fluctuation of the air conditioning control system 200 is narrowed, that is, the motor 11 runs at a stable speed, thereby suppressing the speed fluctuation of the compressor 210, making the air conditioning control system meet the stability conditions.

Those skilled in the art will understand that the scope of disclosure of this application is not limited to the above specific embodiments, and certain elements of the embodiments can be modified and replaced without departing from the spirit of this application. The scope of this application is limited by the appended claims.

What is claimed is:

1. An air conditioning control system, comprising:
a motor; and
a controller, coupled to the motor, wherein the controller is configured to:
filter a received signal by means of a filter function Q(Z), wherein the received signal is a difference between a feedback value of an electrical angular velocity of the motor and a given value of the electrical angular velocity of the motor;
perform phase compensation on a filtered signal by means of a phase compensation function S(Z);
determine a motor speed control signal, by means of a speed regulation function Gpi(Z), according to a phase-compensated signal; and
discretize the motor speed control signal by means of a discrete transfer function Gp(Z), and control a speed of the motor based on a discretized motor speed control signal;
wherein poles of a transfer function of the controller constructed based on the functions Q(Z), S(Z), Gpi(Z), and Gp(Z) are located within a unit circle.

2. The air conditioning control system according to claim 1, wherein a relationship between the functions Q(Z), S(Z), Gpi(Z), and Gp(Z) satisfy a following formula:
$$\vert Q ( Z ) - S ( Z ) \frac{G p i ( Z ) G p ( Z )}{1 + G p i ( Z ) G p ( Z )} \vert < 1.$$

3. The air conditioning control system according to claim 2, wherein the filter function Q(Z) is obtained based on a filtering function q(Z) in a discrete domain and a compensation function Zⁿ, wherein a relationship between the filtering function q(Z) in the discrete domain, the compensation function Zⁿ, and the filter function Q(Z) satisfies a following formula:
$$Q ( Z ) = q ( Z ) * {Z}^{n} .$$

4. The air conditioning control system according to claim 3, wherein
the filtering function q(Z) in the discrete domain is obtained based on a discrete variable Z in the discrete domain, a first preset filtering parameter K1, a second preset filtering parameter K2, a third preset filtering parameter K3, and a fourth preset filtering parameter K4 according to a following formula:
$$q ( Z ) = ( K 1 * Z + K 2 ) / ( {Z}^{2} - K 3 * Z + K 4 ) ;$$
wherein the first preset filtering parameter K1, the second preset filtering parameter K2, the third preset filtering parameter K3, and the fourth preset filtering parameter K4 are all greater than 0.

5. The air conditioning control system according to claim 1, wherein
a discrete transfer function Gp(s) in a complex frequency domain is obtained according to a following formula, based on a current loop proportional coefficient Kp, a current loop operation period T, a dq-axis equivalent inductance L, and a complex variable s in the complex domain:
$$G p ( s ) = \frac{K p}{L {T}^{2} + L s + K p} = \frac{\frac{Kp}{LT}}{{s}^{2} + \frac{1}{T} + \frac{K p}{L T}} , and$$
wherein the discrete transfer function Gp(Z) in the discrete domain is obtained, according toa following formula, based on the current loop proportional coefficient Kp, the current loop operation period T, the dq-axis equivalent inductance L, and a discrete variable Z in the discrete
$$G p ( z ) = \frac{\frac{Kp}{LT}}{\frac{{( Z - 1 )}^{2}}{{T}^{2}} + \frac{Z - 1}{{T}^{2}} + \frac{K p}{L T}} .$$

6. The air conditioning control system according to claim 5, wherein,
the discrete variable Z in the discrete domain is obtained, according to a following formula, based on the current loop operation period T and a constant e:
$$Z = {e}^{T} .$$

7. The air conditioning control system according to claim 4, wherein the phase compensation function S(Z) is obtained, according to the following formula, based on the filtering function q (Z) in the discrete domain and a phase lead component function Z^{m}:
$$S ( Z ) = q ( Z ) * {Z}^{m}$$
wherein the phase compensation function S(Z) is a function of a compensator of the controller, and m is a phase lead compensation amount.

8. The air conditioning control system according to claim 7, wherein,
an input function Y(Z) of the compensator in the discrete domain is obtained, according to a following formula, based on an output function U(Z) of the compensator in the discrete domain, a single time step t in a discretization process, and the discrete variable Z in the discrete domain:
$$Y ( Z ) = \frac{1}{1 + t} {Z}^{- 1} Y ( Z ) + \frac{t}{1 + t} U ( Z ) .$$

9. The air conditioning control system according to claim 8, wherein,
a transfer function G(Z) of the compensator in the discrete domain is obtained based on a single time step t in the discretization process and the discrete variable Z in the discrete domain.

10. The air conditioning control system according to claim 1, wherein the controller comprises a cycle delay device configured to delay control and response of the controller by one cycle.

11. The air conditioning control system according to claim 1, wherein the controller is further configured to:
receive an input speed difference r(Z), and based on a transfer function Grp(Z) of the controller, output a target speed signal, wherein the input speed difference is the difference between the given value of the electrical angular velocity of the motor and the feedback value of the electrical angular velocity of the motor.

12. The air conditioning control system according to claim 11, wherein the controller is further configured to:
when the difference between the feedback value and the given value of the electrical angular velocity of the motor is not zero, adjust a value of an input speed to make the feedback value of the electrical angular velocity approach the given value of the electrical angular velocity.

13. The air conditioning control system according to claim 12, further comprising: a noise transfer function Gd (Z);
wherein the controller is further configured to obtain a target speed signal based on the noise transfer function Gd (Z), the input speed difference value r (Z), the discrete transfer function Gp(Z), the function of the controller Grp (Z), and the speed regulation function Gpi(Z).

14. The air conditioning control system according to claim 13, wherein the function Grp(Z) of the controller is obtained based on the phase compensation function S(Z), the filter function Q(Z), and a function Z-N of a cycle delay device of the controller.

15. The air conditioning control system according to claim 1, wherein the filter function Q(Z) is a function of a low-pass filter of the controller in the discrete domain, and the low-pass filter comprises a cycle delay device configured to delay control and response of the low-pass filter by one cycle.

16. The air conditioning control system according to claim 1, wherein the motor comprises:
a stator configured to generate a rotating magnetic field;
a rotor configured to cut magnetic field lines in the rotating magnetic field to generate current;
wherein the air conditioning control system further comprises a rotor position observer coupled to the controller and configured to observe an initial position of the rotor and a rotational speed of the rotor; and
the controller is further configured to obtain the initial position of the rotor and the rotational speed of the rotor, and adjust the rotational speed based on the functions Q(Z), S(Z), Gpi(Z), and Gp(Z).

17. An air conditioning control method, applied to an air conditioning control system comprising a motor, the air conditioning control method comprising:
filtering a received signal by means of a filter function Q(Z), wherein the received signal is a difference between a feedback value of an electrical angular velocity of the motor and a given value of the electrical angular velocity of the motor;
performing phase compensation on a filtered signal by means of a phase compensation function S(Z);
determining a motor speed control signal, by means of a speed regulation function Gpi(Z), according to a phase-compensated signal; and
discretizing the motor speed control signal by means of a discrete transfer function Gp(Z), and controlling a speed of the motor based on a discretized motor speed control signal;
wherein poles of a transfer function constructed based on the functions Q(Z), S(Z), Gpi(Z), and Gp(Z) are located within a unit circle.

18. The air conditioning control method according to claim 17, wherein a relationship between the functions Q(Z), S(Z), Gpi(Z), and Gp(Z) satisfies a following formula:
$$\vert Q ( Z ) - S ( Z ) \frac{G p i ( Z ) G p ( Z )}{1 + G p i ( Z ) G p ( Z )} \vert < 1.$$

19. The air conditioning control method according to claim 18, wherein the filter function Q(Z) is obtained based on a filtering function q(Z) in a discrete domain and a compensation function Zⁿ, wherein a relationship between the filtering function q(Z) in the discrete domain, the compensation function Zⁿ, and the filter function Q(Z) satisfies a following formula:
$$Q ( Z ) = q ( Z ) * {Z}^{n} ;$$
and
wherein the filtering function q(Z) in the discrete domain is obtained based on a following formula:
$$q ( Z ) = ( K 1 * Z + K 2 ) / ( {Z}^{2} - K 3 * Z + K 4 )$$
wherein Z is a discrete variable in the discrete domain, K1 is a first preset filtering parameter, K2 is a second preset filtering parameter, K3 is a third preset filtering parameter, and K4 is a fourth preset filtering parameter; and
the first preset filtering parameter K1, the second preset filtering parameter K2, the third preset filtering parameter K3, and the fourth preset filtering parameter K4 are all greater than 0.

20. The air conditioning control method according to claim 19, wherein the phase compensation function S(Z) is obtained, according to a following formula, based on the filtering function q(Z) in the discrete domain and a phase lead component function Z^{m}:
$$S ( Z ) = q ( Z ) * {Z}^{m}$$
wherein the phase compensation function S(Z) is a function of a compensator, and m is a phase lead compensation amount.
